(19) United States
(12) Patent Application Publication
(10) Pub. No.: US 2023/0095665 A1
(43) Pub. Date: Mar. 30, 2023

(54) TRAINING DEVICE

(71) Applicant: Joerg DEIKE, Hannover (DE)

(72) Inventor: Joerg DEIKE, Hannover (DE)

(21) Appl. No.: 17/908,485

(22) PCT Filed: Mar. 25, 2021
(86) PCT No.: PCT/DE2021/100299

§ 371 Date: Aug. 31, 2022

(30) Foreign Application Priority Data
Mar. 25, 2020 (DE) 10 2020 108 222.3

(51) Int. Cl. A61H 1/02

(52) U.S. Cl. CPC A61H 1/0292; A61H 2015/0014

(57) ABSTRACT

A training device in the form of a bar has a length that corresponds to at least the length of the spinal column and the head of the user when the user lies down on the training device lengthwise with his/her back, wherein the user's spinal column and head come to lie on the bar. The bar is a composite bar that has a core composed of a hard material and a mantle composed of a soft material.

The invention relates to a training device in the form of a bar that has a length that corresponds to at least the length of the spinal column and the head of the user when the user lies down on the training device lengthwise with his/her back, wherein the user's spinal column and head come to lie on the bar.

Such a training device or also therapy device is known from the magazine article “In der Art der faulen Katze [In the manner of a lazy cat]” (von Arps-Aubert, E.; 2018, May 19; Zeitpunkt [name of magazine]; URL https://www.zeitpunkt.ch/der-art-der-faulen-katze), wherein the bar is configured as a broom stick. For training or for therapy, the user lies on the broom stick lengthwise with his/her back, wherein the user's spinal column and head come to lie on the broom stick due to gravity. The broom stick brings about the result that all the back and chest muscles are relieved of stress or stretched, and that blockages and tensions are relaxed. Tightness and tensions of the muscles in question and back pain attributable to this can thereby be eliminated.

In practice, it has been shown that a training effect or therapy effect cannot be achieved, in part, since the hard surface causes pain in the region of the vertebrae and it is therefore perceived as very unpleasant. In the case of more serious complaints, it is almost impossible to lie on the broom stick for an established period of time, so as to achieve therapeutic effects. Furthermore, the slight diameter of the broom stick is not well suited for achieving sufficient stretching of the muscles in question. Furthermore, many users wish to position the broom stick on a mattress on a bed, so as to complete a training session or therapy session before going to sleep, for example, but in this case the broom stick is pressed into the mattress by the body weight of the user, so that no training effect or therapy effect can be achieved. The broom stick sinks into the mattress, so that the user's back essentially lies on the mattress as usual.

Proceeding from this state of the art, the invention is based on the task of improving a training device in accordance with the preamble of claim 1.

This task is accomplished, in the case of a training device in accordance with the preamble of claim 1, by means of the characterizing features of claim 1. Further developments and advantageous embodiments of the invention are evident from the dependent claims.

The invention relates to a training device in the form of a bar that has a length that corresponds to at least the length of the spinal column and the head of the user when the user lies down on the training device lengthwise with his/her back, wherein the user's spinal column and head come to lie on the bar. According to the invention, it is provided that the bar is a composite bar that has a core composed of a hard material and a mantle composed of a soft material.

Such a training device makes it possible for the users to position the device on a mattress on a bed, so as to be able to complete a training session or therapy session before going to sleep, for example. It has been shown that in this regard, the mantle composed of a soft material prevents the composite bar from being pressed into the mattress by the body weight of the user and sinking into it. At the same time, the core composed of a hard material ensures the rigidity of the composite bar as required for the training or the therapy. Bending of the composite bar is not possible. Therefore a training effect or therapy effect can be achieved on the basis of the embodiment of the training device according to the invention. It has been shown that using the training device for as little as 5-10 minutes already brings about a training effect or therapy effect.

It can be advantageous if the core consists of plastic, wood or metal. Beech wood has proven to be particularly advantageous.

It can be advantageous if the mantle consists of foam material.

Preferably, this is a closed-cell foam material.

Preferably, the foam material is a polyethylene foam material.

It can be advantageous if the core is configured as a tube or preferably as a rod, and the mantle is configured as a tube, wherein the core configured as a tube or a rod is inserted into the tube configured as the mantle, so as to produce the composite bar, preferably in a reversible manner.

If the core is configured as a tube, the training device can be configured to be relatively light, in an advantageous manner. If the core can be taken out of the mantle, the core can be used independently of the mantle, as a training device, on hard floors.

It can be advantageous if the composite bar has an oval or preferably a circular cross-section. By means of an oval cross-section, the contact surface can be increased in size, in such a manner that allowing the composite bar to sink into a mattress, even a very soft mattress, can be even better prevented.

It can be advantageous if the length of the composite bar amounts to 100 to 200 cm, preferably 150 to 200 cm.

It can be advantageous if the diameter of the composite bar amounts to 50 to 90 mm, preferably 60 to 80 mm.

It can be advantageous if the diameter of the core amounts to 15 to 30 mm.

It can be advantageous if the wall thickness of the mantle amounts to 20 to 40% of the diameter of the composite bar.

In the following, the invention will be explained using an exemplary embodiment that is shown in the drawing. In the drawing, the figures show:

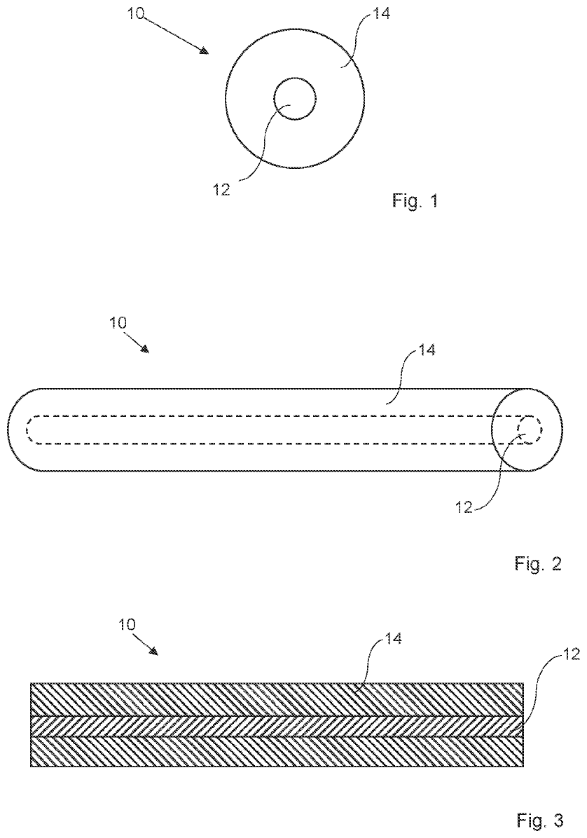

FIG. 1 a schematic top view of an end face of the training device according to the invention,

FIG. 2 a schematic perspective view of the training device according to the invention, and

FIG. 3 a schematic longitudinal sectional view of the training device according to the invention.

If the same reference symbols are used in the figures, these refer to the same parts, so that for the purpose of avoiding repetition, an element that has already been described in a figure description does not need to be discussed again in another figure description.

The training device 10 according to the invention, shown in different schematic representations in FIGS. 1-3, is a composite bar having a core 12 configured as a round rod, composed of a hard material, in particular of wood, and having a mantle 14 configured as a tube, composed of a soft material, in particular of foam rubber. In total, the training device has a round.

The training device 10 has a length of preferably 1.60 m and a diameter of approximately 8 cm. The diameter of the core 12 amounts to approximately 2.5 cm.

Such a training device 10 allows a user to position the same 10 on a mattress, so that the user can then lie down on the training device 10 lengthwise, with his/her back, wherein the spinal column and the head of the user come to lie on the composite bar. In this regard, the embodiment of the training device 10 according to the invention has the rigidity required for training or for therapy, supported by the hard core 12 of the composite bar, wherein the soft mantle 14 of the composite bar advantageously prevents the composite bar from excessively sinking into the mattress, so that the desired training effect or therapy effect can be achieved in spite of the absence of a hard surface underneath.

### REFERENCE SYMBOL LIST

(is part of the description)
10 training device
12 core
14 mantle

1. A training device (10) in the form of a bar that has a length that corresponds to at least the length of the spinal column and the head of the user when the user lies down on the training device lengthwise with his/her back, wherein the user's spinal column and head come to lie on the bar, wherein the bar is a composite bar that has a core (12) composed of a hard material and a mantle (14) composed of a soft material.

2. The training device (10) according to claim 1, wherein the core (12) comprises plastic, wood or metal.

3. The training device (10) according to claim 1, wherein the mantle (14) comprises foam material.

4. The training device (10) according to claim 1, wherein the core (12) is configured as a tube or preferably as a rod, and the mantle (14) is configured as a tube, wherein the core (12) configured as a tube or a rod is inserted into the tube configured as the mantle (14), so as to produce the composite bar, preferably in a reversible manner.

5. The training device (10) according to claim 1, wherein the composite bar has an oval or preferably a circular cross-section.

6. The training device (10) according to claim 1, wherein the length of the composite bar amounts to 100 to 200 cm.

7. The training device (10) according to claim 1, wherein the diameter of the composite bar amounts to 50 to 90 mm, preferably 60 to 80 mm.

8. The training device (10) according to claim 1, wherein the diameter of the core (12) amounts to 15 to 30 mm.

9. The training device (10) according to claim 1, wherein the wall thickness of the mantle (14) amounts to 20 to 40% of the diameter of the composite bar.
